(19) United States
(12) Patent Application Publication
(10) Pub. No.: US 2025/0167485 A1
(43) Pub. Date: May 22, 2025

(54) SOCKET WITH RADIAL ELECTRICAL CONNECTION

(71) Applicant: SANSO INVESTMENT SOLUTIONS, Paris (FR)

(72) Inventors: Antoine Lefaucheux, Grenoble (FR); Ronan Troufflard, Grenoble (FR)

(21) Appl. No.: 18/837,624

(22) PCT Filed: Jan. 24, 2023
(86) PCT No.: PCT/EP2023/051672

§ 371 Date: Aug. 12, 2024

(30) Foreign Application Priority Data
Feb. 14, 2022 (FR) FR2201248

(51) Int. Cl. H01R 13/62; H01R 13/66; H01R 43/26

(52) U.S. Cl. CPC H01R 13/6205; H01R 13/6683; H01R 43/26; H01R 2201/26

(57) ABSTRACT

The invention relates to a radially connected socket, which comprises:
a body,
first electrical contact members, which are housed in said body and translatable in the same plane, called the connection plane, each in a distinct radial direction,
a first magnetic architecture capable of ensuring bonding, via a magnetic effect, of an electrical plug,
means for driving rotation of said first magnetic architecture on itself about an axis, called the principal axis (A), perpendicular to said connection plane, which are arranged to make it assume a plurality of distinct angular positions about said principal axis (A), each distinct angular position being aligned in a distinct radial direction with each contact member of said first electrical contact members,
first actuating means arranged to move each electrical contact member of said first electrical contact members in its radial direction.

### TECHNICAL FIELD OF THE INVENTION

The present invention relates to a radially connected electrical socket, to an electrical connecting system and to a connecting/disconnecting method implemented in such a system.

### PRIOR ART

Patent application WO2017/216458A1 discloses an electrical connecting device that takes the form of a pedestal incorporating a magnetically attractive electrical socket. The electrical socket is positioned centrally and the pedestal has a surface that skirts the front face of connection of the electrical socket. The electrical socket is equipped with magnetic means allowing it to attract, via a magnetic effect, an electrical plug equipped with corresponding magnetic means. The electrical connection is made between the socket and the plug when the two elements are bonded via the magnetic effect. The plug is connected to an electrical apparatus, such as for example a power supply system of an electric vehicle. In one particular embodiment, the device comprises a plurality of annular coils that are integrated into the pedestal and positioned concentrically around the electrical socket. In operation, the pedestal incorporating the electrical socket is for example placed on the ground and connected to the mains by an electrical cable. The plug is freed from the apparatus in proximity to the pedestal. The coils are controlled using a control sequence configured to guide the plug toward the center of the pedestal and therefore toward the electrical socket. The connection is finalized via the magnetic attraction present between the respective magnetic means of the socket and plug.

The socket must be designed to achieve a number of objectives:
allow electrical continuity between the plug and socket, thereby limiting hot spots;
mask the electrical contacts of the socket when the plug is not present and when the socket is not in use;
ensure a certain level of seal-tightness to liquid but also to dust when the socket is not in use;
prevent access to the electrical contacts when the plug is connected to the socket;
allow easy disconnection of the plug, by limiting the force that has to be exerted to disconnect the plug from the socket;
ensure protection of individuals by masking the electrical contacts of the socket, even should the plug be torn out of the socket.

A number of solutions meeting some of these objectives have already been disclosed in the prior art.

In patent application WO2012/032230A1, the socket uses pivoting flaps that mask the electrical contacts when the plug is not connected. Each flap is pivotally mounted on a shaft independently and urged by a spring. When the electrical contacts are moved to outside the socket, they each push one flap against its spring.

Another solution has been described in patent application WO2017/046469A1, in which the socket also uses pivoting flaps. These flaps are moved by the stage that bears the electrical contacts by virtue of a cam/cam follower mechanism.

In the prior-art solutions, the electrical contacts often take the form of pins that bear against a flat contact or that get housed in a cavity. In the first case, the electrical contact may cause the presence of hot spots. In the second case, the cavities are exposed to water and dust. Furthermore, since connection is intended to be achieved automatically (without external intervention), correct indexation is also important because each pin must be inserted into one distinct cavity.

Moreover, the pivoting-flap architecture used to mask the electrical contacts is complex and fragile and does not allow continuity of service over time to be guaranteed. In addition, integration of such a socket into a device such as the one described in patent application WO2017/216458A1 does not necessarily allow access to the electrical contacts to be limited when the plug is connected to the socket, nor the seal- tightness of the device to be guaranteed.

Patent application DE102020116623A1 describes an electrical connecting system used in a solution for charging an electric vehicle.

A first aim of the invention is therefore to provide an electrical connecting device that comprises a socket with an architecture that allows a number of the objectives defined above to be achieved.

### DESCRIPTION OF THE INVENTION

This aim is achieved via a radially connected electrical socket, which comprises:
a body,
actuating means,
a control unit configured to control said actuating means,
first electrical contact members, which are housed in said body, intended to be connected to an electrical supply system and translatable in the same plane, called the connection plane, each in a distinct radial direction,
a first magnetic architecture capable of ensuring bonding, via a magnetic effect, of an electrical plug complementary to said socket,
means for driving rotation of said first magnetic architecture on itself about an axis, called the principal axis, perpendicular to said connection plane, which are arranged to make it assume a plurality of distinct angular positions about said principal axis, each distinct angular position being aligned in a distinct radial direction with each contact member of said first electrical contact members,
said actuating means being configured to actuate said rotation-driving means, and to move each electrical contact member of said first electrical contact members in its radial direction.

According to a first embodiment, the socket comprises:
a part for protecting the first electrical contact members, which is able to be actuated to rotate on itself about the principal axis between at least a first angular position in which it occludes accesses to each of the electrical contact members of said first electrical contact members and a second angular position in which it frees each of said accesses,
said actuating means being configured to drive rotation of said protecting part.

According to a second embodiment, the socket comprises:
a part for protecting the first electrical contact members, comprising a fixed annular body equipped with a plurality of radial apertures each located facing one distinct electrical contact member of said first electrical contact members and a plurality of occluding shutters each able to be actuated to move between at least a first position in which it frees the radial aperture with which it is associated and a second position in which it occludes the radial aperture with which it is associated,
said actuating means being configured to drive motion of the occluding shutters.

According to one particularity, the socket comprises:
a rotary ring, which is able to be actuated to rotate, and which is arranged to drive translation of the first magnetic architecture along the principal axis between a low position and a high position, via at least one cam and cam follower mechanism,
said actuating means being configured to drive rotation of said rotary ring.

According to another particularity, the driving means comprise a rotary driving part coaxial with said principal axis, and with which said first magnetic architecture rotates as one.

The invention also relates to an electrical connecting system comprising a socket and a plug connectable to said socket, wherein:
the socket is a radially connected electrical socket such as defined above,
the plug comprises a second magnetic architecture complementary to said first magnetic architecture belonging to the socket and a plurality of second electrical contact members arranged in a plurality of distinct radial directions about the principal axis,
the first magnetic architecture and second magnetic architecture are configured to make the plug assume a defined orientation about the principal axis when the plug is bonded against the socket via the magnetic effect,
each electrical contact member of said first electrical contact members of the socket is arranged to be connected to one distinct electrical contact member of said second electrical contact members of the plug, via translation in a radial direction,
the system comprises means for detecting the orientation of the plug when the latter is magnetically bonded to the socket, and means for determining the angular position to be imparted to said first magnetic architecture depending on said determined orientation, among a plurality of distinct angular positions,
said control unit is configured to control the actuating means with a view to:
positioning the first magnetic architecture in the determined angular position,
moving each electrical contact member of said first electrical contact members in its radial direction when the first magnetic architecture is positioned in the determined angular position.

The invention also relates to a connecting method implemented in an electrical connecting system such as defined above, wherein the phase of connecting the plug to the socket comprises the following steps:
mechanically bonding the plug against the socket via a magnetic effect,
detecting the orientation of the plug with respect to the socket about the principal axis,
determining the angular position to be imparted to said first magnetic architecture depending on said determined orientation, among a plurality of distinct angular positions,
if necessary, controlling the actuating means so as to actuate the means for driving rotation of the first magnetic architecture so as to position it in the determined angular position,
controlling the actuating means so as to move each electrical contact member of said first electrical contact members in its radial direction so as to connect it to the corresponding electrical contact member of said second electrical contact members belonging to the plug.

According to one particularity, the connecting method comprises a step of controlling the actuating means so as to actuate rotation of the rotary ring so as to make the first magnetic architecture pass from its low position to its high position, prior to the step of mechanically bonding the plug against the socket.

According to another particularity, the connecting method comprises a step of controlling the actuating means so as to actuate rotation of the protecting part to its second angular position and to free the accesses to each of the electrical contact members of said first electrical contact members.

The invention also relates to a disconnecting method implemented in an electrical connecting system such as defined above, wherein the phase of disconnecting the plug to the socket comprises the following steps:
controlling the actuating means so as to actuate rotation of the rotary ring and to make the first magnetic architecture pass from its high position to its low position,
controlling the actuating means so as to actuate the rotation-driving means and to make the first magnetic architecture rotate by a defined first angle,
controlling the actuating means so as to actuate each of said first electrical contact members and mechanically and electrically disconnect them from the second electrical contact members.

According to one particularity, the disconnecting method comprises a step of controlling the actuating means so as to actuate rotation of the protecting part with a view to occluding said accesses to the first electrical contact members.

According to another particularity, the disconnecting method comprises a step of controlling the actuating means so as to actuate rotation of the means for driving the first magnetic architecture, by an angle opposite to said first angle.

### BRIEF DESCRIPTION OF THE FIGURES

Other features and advantages will become apparent in the following detailed description given with reference to the appended drawings, in which:

FIG. 1 schematically shows the electrical connecting system of the invention;

FIG. 2 shows a first exploded view of the electrical socket and plug employed in the electrical connecting system of the invention;

FIG. 3 shows a second exploded view of the electrical socket and plug employed in the electrical connecting system of the invention;

FIG. 4 shows a perspective view of the socket to which the plug is connected;

FIG. 5 shows the rotary ring employed in the socket of the invention;

FIGS. 6A and 6B show the magnetic architecture socket-side, in the low position and in the high position, respectively;

FIG. 7 illustrates one variant of embodiment of the protecting part employed in the electrical socket of the invention;

FIG. 8 shows one example of embodiment of the two magnetic architectures employed on the one hand socket-side and on the other hand plug-side.

### DETAILED DESCRIPTION OF AT LEAST ONE EMBODIMENT

The invention is generally applicable to an electrical connecting system, which may notably be employed in an electrical installation intended for recharging an electrical apparatus, such as an electric vehicle for example. Other applications could of course be envisioned.

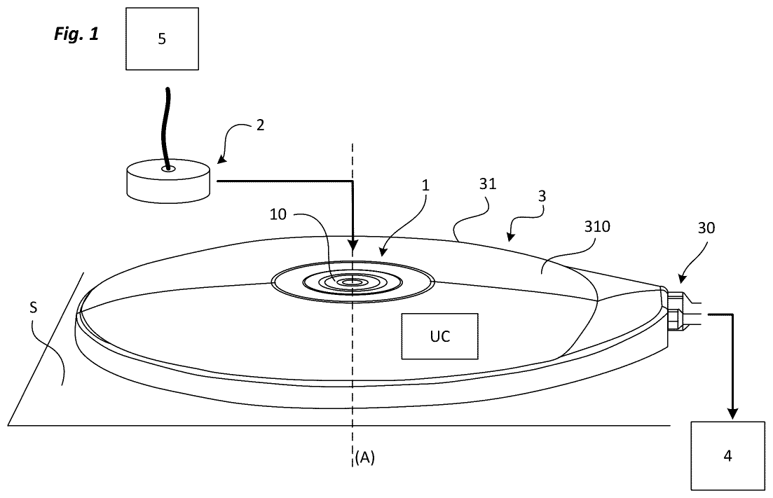

With reference to FIG. 1, the system is made up of two portions, one of the two portions being intended to be connected to an electrical supply circuit, for example to the mains 4, and the other portion being intended to be connected to an electrical apparatus 5 to be powered, for example to a power supply system of an electric or hybrid vehicle.

Any solution allowing electrical connection to the electrical apparatus or electrical supply circuit may be envisioned, such as a cable, conductive rod, or some other equivalent solution, etc.

The first portion of the system comprises an electrical socket (designated socket 1 below) and the second portion comprises an electrical plug (designated plug 2 below) intended to be mechanically and electrically connected to the socket 1.

The system advantageously allows the plug 2 to be mechanically connected to the socket 1 automatically, without the intervention of an operator or robot, solely using magnetic and gravitational means.

An assembly direction, corresponding to a principal axis (A) along which the plug 2 is brought to bear mechanically against the socket 1, is defined here and will be referred to in the remainder of the description.

In the remainder of the description, the terms “front” and “rear” and “high” and “low” and “higher” and “lower” are to be considered with reference to longitudinal position along the principal axis (A).

In the remainder of the description, the terms “inside” and “outside” are to be considered with reference to coaxial position with respect to the principal axis (A).

When the plug 2 is connected to the socket 1, the front portion of the plug 2 is brought to bear mechanically against the front portion of the socket 1.

An electrical connecting device incorporating the socket 1 is defined. This device advantageously comprises a pedestal 3 to be placed on a holder (for example the ground S—the principal axis (A) is then orthogonal to the ground). The pedestal 3 may comprise one or more connectors 30 allowing it to be connected to the mains 4 and to a communication system. Electrical connections integrated into the pedestal 3 allow the electrical socket 1 to be connected to said connectors 30.

With reference to FIG. 1, the pedestal 3 comprises a closed jacket 31, the central portion of which is occupied by the socket 1.

The electrical socket 1 comprises a front land 10 via which it is mechanically connected with the plug 2. This front land 10 may be of any suitable shape, flat or curved, concave or convex.

The jacket 31 skirts the socket 1 and defines a front surface 310 that skirts the front land 10 of said socket 1. This front surface 310 lies beyond the front land 10 of the socket 1 and is not dedicated to connection. Under this surface, the jacket 31 of the device incorporates magnetic and/or mechanical guiding means configured to guide the plug 2 toward the socket 1 as the plug 2 approaches. Non-limitingly, patent application No. WO2017/216458A1 describes an operating principle whereby the plug 2 is connected to the socket 1 by executing a control sequence of coils integrated into the jacket.

The front land 10 of the socket 1 is oriented transversely to the principal axis (A). The front surface 310 of the pedestal 3, around the socket 1, may be planar in the same plane as that formed by the front land 10 of the socket 1, or of a concave or convex curved shape (as in the appended figures).

The socket 1 is equipped with a first magnetic architecture 11 arranged transversely to the main axis (A), allowing it to attract the plug 2, which for its part is equipped with a corresponding second magnetic architecture 21. When the plug 2 is bonded via a magnetic effect to the socket 1, an electrical connection is also made between first electrical contact members of the socket 1 and second electrical contact members of the plug 2.

The two magnetic architectures used make it possible to ensure bonding of the plug 2 to the socket 1 via a magnetic effect. Various magnetic architectures, allowing the plug 2 to be bonded to the socket 1, are notably described in patent EP3317926B1 and in patent application WO2020/229321A1. These are applicable to the present invention but are to be considered non-limiting. The two magnetic architectures advantageously comprise a plurality of permanent magnets. According to one particularity, when the plug is in a suitable angular position with respect to the socket the two magnetic architectures act attractively to make the connection, or repulsively when the plug must be withdrawn from the socket during disconnection.

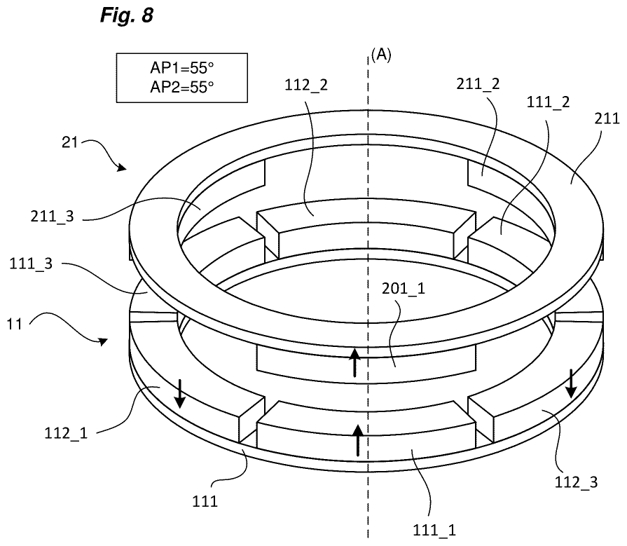

By way of example, FIG. 8 shows the first magnetic architecture 11 present on the side of the socket 1 and the second magnetic architecture 21 present on the side of the plug 2. The two magnetic architectures shown comprise a ferromagnetic yoke 111, 211 and one or more permanent-magnet segments fastened to said yoke.

In the first magnetic architecture, three permanent magnets 111_1, 111_2, 111_3 of a first set each for example extend over an angular range AP1 of 55° on their annular segment and three permanent magnets 112_1, 112_2, 112_3 of a second set for example extend over an angular range AP2 of 55°.

Each of the three new permanent magnets of the second set is interposed between two permanent magnets of the first set, leaving a regular non-zero angular interval with these two magnets of the first set. The regular angular interval 11 between two adjacent magnets is about 5°.

The permanent magnets of the first set and those of the second set are magnetically oriented along the principal axis (A) and in opposite directions.

The second magnetic architecture 21 has only a first set of three permanent magnets 211_1, 211_2, 211_3, which are identical to the permanent magnets of the first magnetic architecture.

It will be noted that the two magnetic architectures 11, 21 are configured to ensure bonding of the plug 2 against the socket 1, via an attractive magnetic effect, with a given orientation about the principal axis. The two magnetic architectures 11, 21 are configured so that the plug 2 may assume a plurality of distinct angular positions when it is bonded to the socket 1 via the magnetic effect.

For example, with the magnetic architectures shown in FIG. 8, the plug 2 may assume three distinct angular positions that are offset from each other by 120°. The plug 2 may be in a first angular position, called the 0° position, a second angular position, called the −120° position, or in a third angular position, called +120° position.

Of course, the magnetic arrangements (angular ranges of the magnets and angular intervals between magnets) of the magnetic architecture may be adjusted.

Arbitrarily, for example, the plug 2 is considered to be correctly oriented with respect to the socket 1 when it is in its 0° angular position. In this position, the first electrical contact members associated with the socket 1 and the second contact members associated with the plug 2 are electrically compatible and the electrical connection is correct. For example, first socket-side “power” contacts are connected to first plug-side “power” contacts, second socket-side “power” contacts are connected to second plug-side “power” contacts, and socket-side “data” contacts are connected to plug-side “data” contacts. Of course, depending on the type of mains grid, other configurations may be possible.

According to the invention, the electrical connection between the socket 1 and the plug 2 is made in a plurality of radial directions. First electrical contact members of the socket 1 are thus connected via radial movement to second electrical contact members of the plug 2.

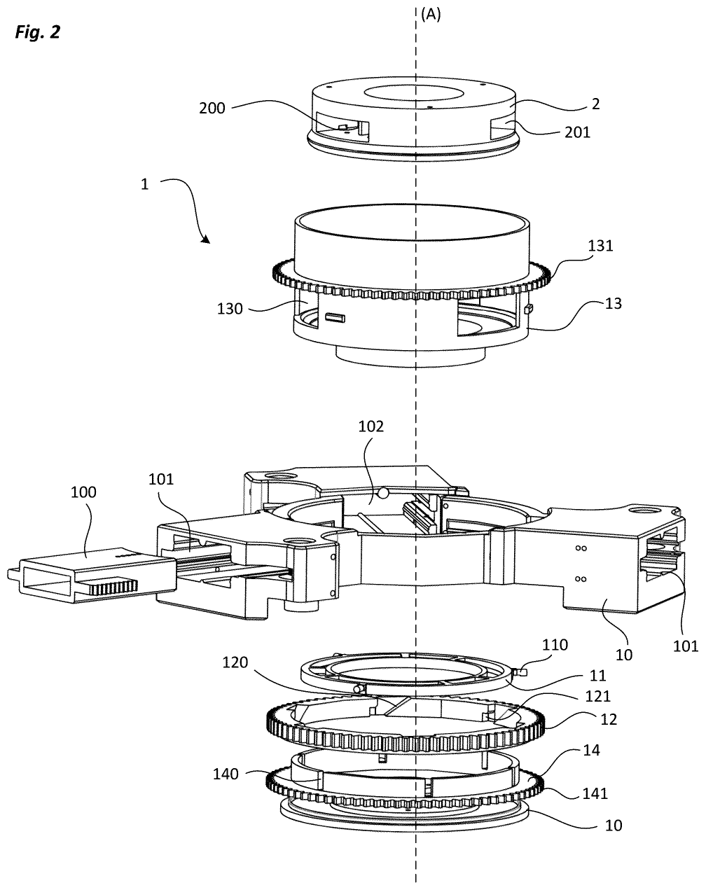

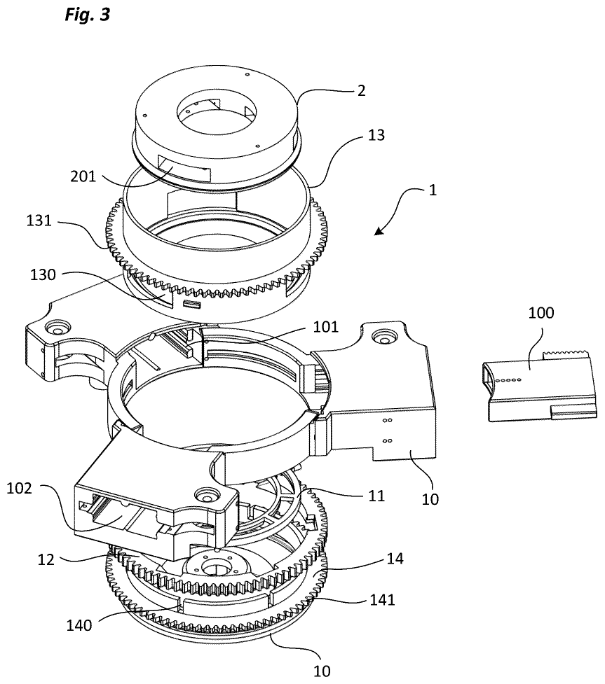

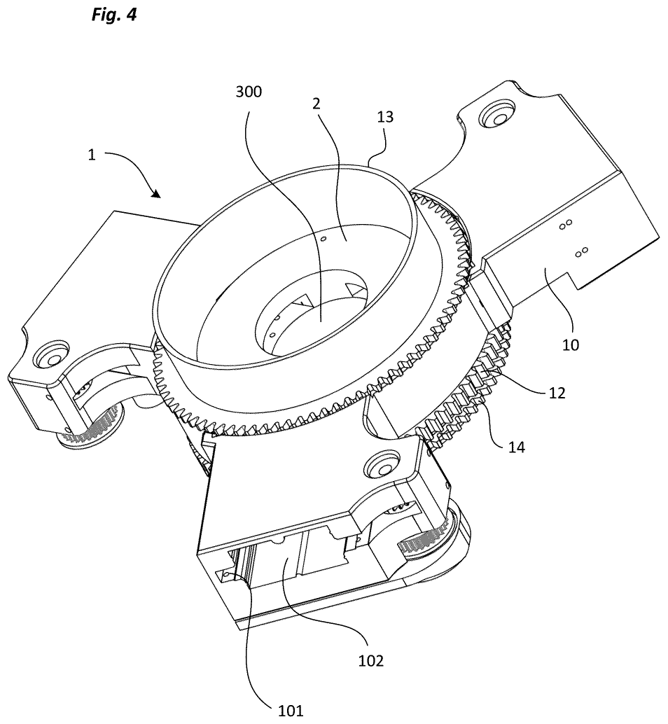

According to the invention, with reference to FIG. 2, FIG. 3 and FIG. 4, the socket 1 comprises a body 10, which is advantageously integrated into and fastened to the jacket 31 of the pedestal 3, and a core housed in said body 10.

The core of the socket comprises:
the first magnetic architecture 11, which is able to be actuated to translate along the principal axis (A) and to rotate about the principal axis (A),
a rotary ring 12 for translating the first magnetic architecture 11, the ring 12 being rotatable on itself about the principal axis (A),
a protecting part 13, which is rotatable on itself about the principal axis (A),
a driving part 14, which is able to be actuated to rotate on itself about the principal axis (A), and to which the first magnetic architecture is secured.

The protecting part 13 and the driving part 14 are annular parts positioned coaxially with the principal axis (A).

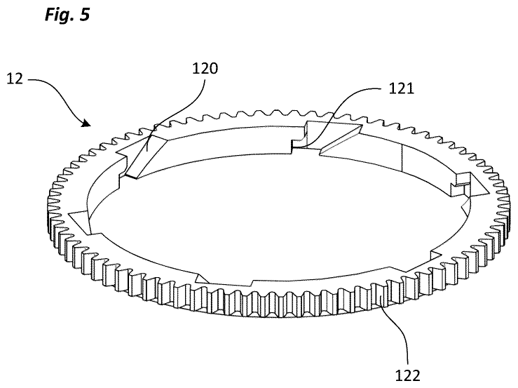

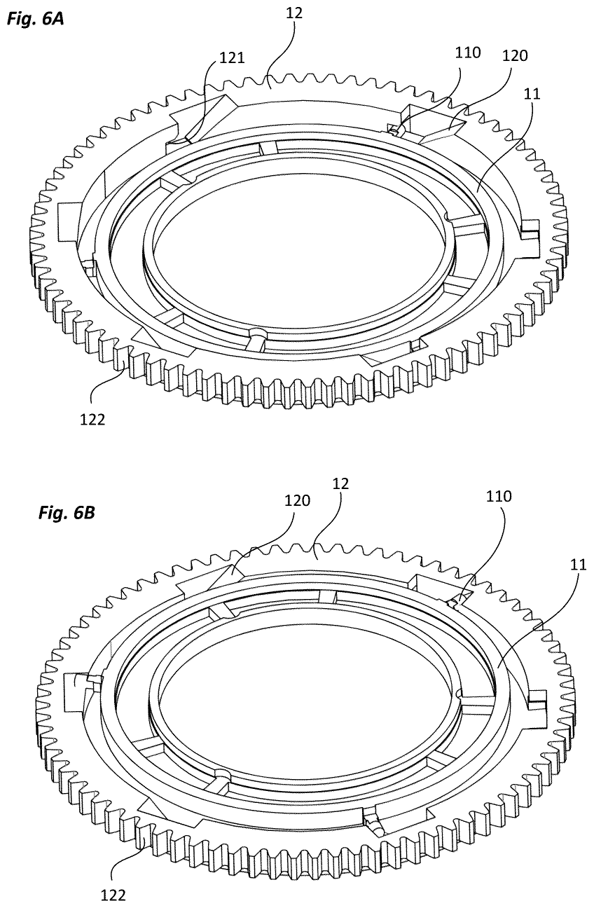

With reference to FIG. 5, FIG. 6A and FIG. 6B, the rotary ring 12 comprises on its perimeter a plurality of cams 120, which interact with lugs 110 present on the magnetic architecture, the lugs 110 each playing the role of a cam follower. Due to the cam/cam follower mechanisms, rotation of the ring 12 drives translation of the first magnetic architecture along the principal axis (A).

The first magnetic architecture is translated along the principal axis (A) by way of slits 140 formed in the driving part 14 (FIG. 2), each of which interact with one distinct lug 110 present on the magnetic architecture 11.

The low position (FIG. 6A) is assumed when presence of the plug 2 is not detected.

The high position (FIG. 6B) is assumed when presence of the plug 2 is detected, so as to place the socket 1 under conditions allowing connection with the plug 2.

The rotary ring 12 bears means for locking the first magnetic architecture 11 in its high position and in its low position. In the low position, it may be a question of one or more notches 121 each arranged to interact with a distinct lug 110 borne by the first magnetic architecture 11.

The socket 1 comprises first means for actuating rotation of the rotary ring 12. These first actuating means may comprise an electric motor (not shown) and a rack mechanism or equivalent, comprising teeth 122 formed on the external perimeter of the ring 12.

The first electrical contact members 100 are housed in the body of the socket 1. The first electrical contact members 100 are each translatable in a plane perpendicular to the principal axis (A) and in a distinct radial direction, perpendicular to the principal axis (A). The first electrical contact members 100 are for example three in number, each member comprising one or more electrical contacts. The three first electrical contact members are for example angularly offset from each other by 120°, about the principal axis (A). The body 10 comprises a plurality of slideways 101 allowing translation of each of the first contact members in its radial direction. FIGS. 2 and 3 show only one of the three first electrical contact members 100. The slideways are formed in radial apertures 102 of the body 10 of the socket, through which apertures each electrical contact member 100 is able to be translated.

The protecting part 13 is arranged coaxially with the driving part 14. These two movable parts are each annular in shape and may each rotate on itself independently, about the principal axis (A).

The role of the protecting part 13 is to mask the first electrical contact members 100 and thus block their access until the plug 2 is mechanically connected to the socket 1. It is possible to control rotation of the protecting part 13 on itself about the principal axis (A), so as to move it angularly by a non-zero angle, for example set to 55°. In a first angular position, for example of 0°, the protecting part occludes accesses to the first electrical contact members 100, and in a second position, for example of 55°, it frees the accesses to the first electrical contact members 100. The protecting part 13 thus comprises three radial apertures 130, which are intended to be passed through by the first electrical contact members 100 when the protecting part 13 is in its second position.

The socket 1 thus comprises second means for actuating rotation of the protecting part 13.

These second actuating means may comprise an electric motor and a rack mechanism or equivalent, comprising teeth 131 formed on the external perimeter of the protecting part.

The driving part 14 is used to drive rotation of the first magnetic architecture 11 belonging to the socket 1. It is also able to be actuated to rotate on itself about the principal axis (A). By driving rotation of the first magnetic architecture 11, it also causes the plug 2 to rotate when the latter is magnetically bonded to the socket 1. The role of the driving part 14 is, if necessary, to adapt the orientation of the plug 2 with respect to the socket 1 and therefore the orientation of its second electrical contact members 200 with respect to the first electrical contact members 100 housed in the body of the socket 1. In other words, when the plug 2 is bonded mechanically, via the magnetic effect, against the socket 1, its orientation is uncertain to within 120°. It may therefore prove necessary to reposition it so that each of its second electrical contact members 200 is facing the electrical contact member of the socket 1 that corresponds thereto.

The driving part 14 is thus able to be actuated to rotate on itself so as to assume three distinct angular positions, for example defined at 0°, −120° and +120°.

The socket 1 comprises third means for actuating rotation of the driving part 14. These third actuating means may comprise an electric motor and a rack mechanism or equivalent, comprising teeth 141 formed on the external perimeter of the driving part 14.

The first electrical contact members of the socket 1 and the second electrical contact members 200 of the plug 2 are connected electrically in radial directions, which are angularly offset from each other by 120°. The second electrical contact members present on the plug 2 are thus made accessible via radial apertures 201 formed through the body of the plug 2. During connection, each electrical contact member of the first electrical contact members passes through one distinct radial aperture 201 present in the body of the plug 2, to be connected to one distinct electrical contact member of the second electrical contact members 200.

The socket 1 comprises fourth means for actuating translation of each electrical contact member of the first electrical contact members 100. These fourth actuating means may comprise a belt (not shown) driven by an electric motor and interacting with gears present in each electrical contact member. Driving of the belt by an electric motor simultaneously actuates translation of all the electrical contact members in their radial direction.

The system comprises a control unit UC (FIG. 1) configured to control the actuating means of the socket, i.e. the first actuating means, the second actuating means, the third actuating means and the fourth actuating means, taking into account the advancement of the connection sequence or the advancement of the disconnection sequence. This control unit UC may be housed in the jacket 31 and then forms part of the connecting device incorporating the socket 1. It may also be integrated into the body 10 of the socket 1. It is configured to manage operation of the socket 1, notably the movement of its parts and of the contact members, by controlling the motors.

The first actuating means, the second actuating means, the third actuating means and the fourth actuating means may be defined, generally, as actuating means. They are for example housed in the body 10 of the socket or in the jacket 31 of the device.

The socket 1 comprises means for detecting the orientation of the plug 2 with respect to the socket 1, about the principal axis. Depending on data delivered by the detecting means and representative of this orientation, the control unit UC determines whether or not the plug 2 must be rotated, and the direction of rotation to be applied to the plug 2. The plug 2 is rotated by making the driving part 14 rotate between its various angular positions when the plug 2 is magnetically bonded to the socket 1.

It will be noted that the socket 1 and plug 2 both have an axial central aperture, forming an axial central passage 300, even when the plug 2 is connected to the socket, this passage 300 forming a removal zone, for example for collecting various objects, draining rainwater, etc.

Of course, the control unit UC and the various actuating means are powered electrically, for example by the mains or any other means.

With the architecture described above, the connection sequence is as follows:
Detection of the presence of plug 2 nearby.
When presence of the plug 2 is detected, the control unit UC controls the first actuating means so as to actuate rotation of the rotary ring 12, rotation of the ring 12 causing translation of the first magnetic architecture 11 from its low position to its high position (FIG. 6B). The rotary ring is driven until the magnetic architecture is locked in its high position.
The plug 2 is mechanically bonded against the socket, via magnetic attraction between the two magnetic architectures. The plug 2 is bonded in an angular position of within 120° with respect to the socket 1.
The control unit UC controls the second actuating means so as to drive rotation of the protecting part 13 and thus free the accesses to the first electrical contact members 100, housed in the body 10.
The protecting part 13 for example rotates by an angle of 55°.
Using the data delivered by the detecting means, the control unit UC determines the orientation of the plug 2 with respect to the socket 1.
If the plug 2 is not correctly oriented with respect to the socket 1 (not in the angular position of 0° defined above), the control unit UC controls the third actuating means so as to drive rotation of the driving part 14. By rotating, the driving part drives rotation of the first magnetic architecture 11. Since the plug 2 is bonded via the magnetic effect, it is also driven to rotate until each of its electrical contact members 200 is placed facing the corresponding electrical contact member 100 of the socket 1.
The control unit UC controls the fourth actuating means so as to drive translation of each electrical contact member of the first electrical contact members 100 and thus ensure connection of the first electrical contact members 100 to the second electrical contact members 200 present in the plug 2.
The power supply system 5 is ready to charge.

With the architecture described above, the disconnection sequence is as follows:
The control unit UC controls the first actuating means so as to drive rotation of the ring 12, unlock the first magnetic architecture 11 and return it to its low position and thus magnetically debond it from the second magnetic architecture belonging to the plug 2.
The control unit UC controls the third actuating means so as to drive rotation of the driving part 14, and thus rotate the first magnetic architecture 11. The rotation is through an angle sufficient for the permanent magnets present on the first magnetic architecture 11 and those present on the second magnetic architecture to start repulsing. The angle of rotation is for example +60°.
The control unit UC controls the first actuating means so as to actuate rotation of the rotary ring 12 and lock the first magnetic architecture 11 in its low position (FIG. 6A).
The control unit UC controls the fourth actuating means so as to retract the first electrical contact members 100 and mechanically and electrically disconnect them from the second electrical contact members 200.
The control unit UC controls the second actuating means so as to drive rotation of the protecting part 13 and close the access to the first electrical contact members 100.
The plug 2 may then be mechanically disconnected.
The control unit UC controls the third actuating means so as to make the driving part 14 rotate and return the first magnetic architecture to its initial position of 0°.

In respect of operation, it is possible to pool the electric motors employed in the aforementioned actuating means. Specifically, it is possible to use a single or two motors to drive the various parts of the socket. It may for example be envisioned to use a first electric motor to drive rotation of the various parts (12, 13, 14) and a second electric motor to drive translation of the first electrical contact members 100.

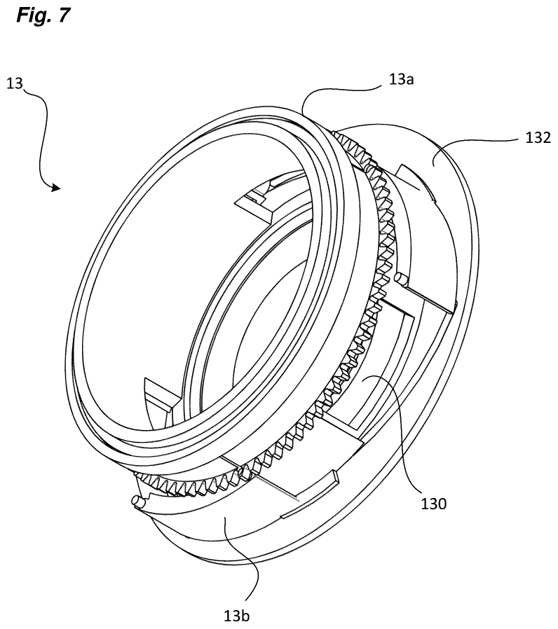

FIG. 7 shows one variant of embodiment of the protecting part 13. In this variant, the protecting part 13 comprises an annular body 13a of identical shape to the one described above with reference to FIGS. 1 to 6B, and occluding shutters 13b. The body 13a of the protecting part is fixedly positioned in the electrical socket, so that each of its radial apertures 130 is facing one distinct electrical contact member of the first electrical contact members 100. The shutters 13b are positioned outside the body 13a of the protecting part, each being associated with one distinct radial aperture 130 present in the body. Each shutter 13b is controllable between two positions, a first position in which it closes the radial aperture 130, blocking the access to the corresponding electrical contact member, and a second position in which it frees the radial aperture 130 and the access to the corresponding contact member. The annular body 13a may have a collar 132 forming a transverse land for supporting and guiding the shutters.

Moreover, the system may comprise various means configured to manage various cases of malfunction, notably malfunctions in the actuating means of the socket. Mention may notably be made of the possibility of using manual means to actuate the ring 12, for example to return the first magnetic architecture 11 to its low position and thus facilitate disconnection of the system, in the event of malfunction of the means for actuating rotation of the ring 12. These means may comprise a key to be inserted into the body of the socket, which key is configured to mesh with the ring 12. It is also possible to provide a backup electric power supply unit for powering the system, and notably for activating its electric motors. This unit may be internal to the system or connectable from outside.

The solution of the invention thus has many advantages, among which:
it prevents access to the electrical contact members of the socket when they are not in use;
the solution socket-side is particularly seal-tight because all the accesses may be occluded;
it allows, without mechanical stress, for the plug to be positioned to within 120°;
it uses conventional actuating means such as a rack, electric motor, drive wheels, etc.;
it is original in its design, notably because of the radial connection;
it allows an axial central passage to be freed up so as to ensure removal of water, debris, dust and other objects, without disrupting operation of the system.

1-12. (canceled)

13. An apparatus comprising a socket, the socket being a radially-connected electrical socket that comprises: a body, an actuator, a control unit configured to control the actuator, first electrical contact members that are housed in the body, each of which is configured to be translatable along a distinct radial direction in a connection plane, a first magnetic architecture for ensuring bonding, via a magnetic effect, of an electrical plug that is complementary to the socket, a driver for driving rotation of the first magnetic architecture on itself about a principal axis that is perpendicular to the connection plane, wherein the magnetic architecture assumes a plurality of distinct angular positions about the principal axis, each distinct angular position being aligned in a distinct radial direction with each contact member of the first electrical contact members, the actuator being configured to actuate the rotator and to move each electrical contact member of the first electrical contact members in a radial direction thereof.

14. The apparatus of claim 13, wherein the socket further comprises a protecting part for protecting the first electrical contact members, the protecting part being actuatable to rotate on itself about the principal axis between a first angular position, in which the protecting part occludes access to each of the electrical contact members of the first electrical contact members, and a second angular position in which the protecting part enables access to each of the electrical contact members, wherein the actuator is configured to drive rotation of the protecting part.

15. The apparatus of claim 13, wherein the socket further comprises a protecting part for protecting the first electrical contact members, wherein the protecting part comprises a fixed annular body that is equipped with a plurality of radial apertures, each of which is located facing one distinct electrical contact member of the first electrical contact members and a plurality of occluding shutters, each of which is actuatable to move between at least a first position, in which the occluding shutter frees the radial aperture with which it is associated, and a second position, in which the occluding shutter occludes the radial aperture with which it is associated, wherein the actuator is configured to move the occluding shutters.

16. The apparatus of claim 13, wherein the socket further comprises a rotary ring that is actuatable to rotate and that is arranged to drive translation of the first magnetic architecture along the principal axis between a low position and a high position via a cam and cam follower mechanism, wherein the actuator is configured to drive rotation of the rotary ring.

17. The apparatus of claim 13, wherein the driver comprises a rotary driving part that is coaxial with the principal axis and with which the first magnetic architecture rotates as one.

18. The apparatus of claim 13, further comprising an electrical connecting system that comprises the socket and the plug, wherein the plug is connectable to the socket, wherein the plug comprises a second magnetic architecture that is complementary to the first magnetic architecture and a plurality of second electrical contact members arranged in a plurality of distinct radial directions about the principal axis, wherein the first magnetic architecture and the second magnetic architecture are configured to cause the plug to assume a defined orientation about the principal axis when the plug is magnetically bonded against the socket, wherein each electrical contact member of the first electrical contact members of the socket is arranged to be connected to one distinct electrical contact member of the second electrical contact members of the plug via translation in a radial direction, wherein the electrical connecting system further comprises an orientation detector for detecting orientation of the plug when the plug is magnetically bonded to the socket, wherein the electrical connecting system further comprises an angular position determiner that determines an angular position that is to be imparted to the first magnetic architecture depending on the determined orientation, the angular position being one of a plurality of distinct angular positions, wherein the controller is further configured to control the actuator to carry out steps of: positioning the first magnetic architecture in the determined angular position and moving each electrical contact member of the first electrical contact members in a radial direction thereof when the first magnetic architecture has been positioned in the determined angular position.

19. A method comprising connecting an electrical plug to a socket in an electrical connecting system that comprises the socket and the electrical plug, the electrical plug being complementary to the socket, the socket being a radially-connected electrical socket that comprises: a body, an actuator, a control unit configured to control the actuator, first electrical contact members that are housed in the body, each of the members being configured to be connected to and to be translatable along a distinct radial direction in a connection plane, a first magnetic architecture for ensuring bonding, via a magnetic effect, of the plug, a driver for driving rotation of the first magnetic architecture on itself about a principal axis that is perpendicular to the connection plane, which are arranged to make the magnetic architecture assume a plurality of distinct angular positions about the principal axis, each distinct angular position being aligned in a distinct radial direction with each contact member of the first electrical contact members, the actuator being configured to actuate the rotator and to move each electrical contact member of the first electrical contact members in a radial direction thereof, wherein the plug is connectable to the socket, wherein the plug comprises a second magnetic architecture that is complementary to the first magnetic architecture and a plurality of second electrical contact members arranged in a plurality of distinct radial directions about the principal axis, wherein the first magnetic architecture and the second magnetic architecture are configured to cause the plug to assume a defined orientation about the principal axis when the plug is magnetically bonded against the socket, wherein each electrical contact member of the first electrical contact members of the socket is arranged to be connected to one distinct electrical contact member of the second electrical contact members of the plug via translation in a radial direction, wherein the electrical connecting system further comprises an orientation detector for detecting orientation of the plug when the plug is magnetically bonded to the socket, wherein the electrical connecting system further comprises an angular position determiner that determines an angular position that is to be imparted to the first magnetic architecture depending on the determined orientation, the angular position being one of a plurality of distinct angular positions, wherein the controller is further configured to control the actuator to carry out steps of: positioning the first magnetic architecture in the determined angular position and moving each electrical contact member of the first electrical contact members in a radial direction thereof when the first magnetic architecture has been positioned in the determined angular position, wherein the connecting method comprises connecting the plug to the socket, wherein connecting the plug to the socket comprises mechanically bonding the plug against the socket via a magnetic force, detecting orientation of the plug with respect to the socket about the principal axis, determining an angular position to be imparted to the first magnetic architecture depending on the determined orientation, the determined angular position being one of a plurality of distinct angular positions, if necessary, controlling the actuator so as to actuate the driver of the first magnetic architecture so as to position the first magnetic architecture in the determined angular position, and controlling the actuator so as to move each electrical contact member of the first electrical contact members in a radial direction thereof so as to connect the electrical contact member to a corresponding electrical contact member of the second electrical contact members belonging the plug.

20. The method of claim 19, further comprising, prior to mechanically bonding the plug against the socket, controlling the actuator so as to actuate rotation of the rotary ring to cause the first magnetic architecture to pass from a low position to a high position thereof.

21. The method of claim 19, further comprising providing a protecting part for protecting the first electrical contact members, the protecting part being actuatable to rotate on itself about the principal axis between a first angular position, in which it occludes access to each of the electrical contact members of the first electrical contact members, and a second angular position in which it enables access to each of the electrical contact members, wherein the actuator is configured to drive rotation of the protecting part, and controlling the actuator so as to actuate rotation of a protecting part to the second angular position and to thus provide access to each of the electrical contact members of the first electrical contact members.

22. A method comprising disconnecting an electrical plug from a socket in an electrical connecting system that comprises comprising an electrical connecting system that comprises the socket and the electrical plug, wherein the electrical plug is complementary to the socket, the socket being a radially-connected electrical socket that comprises: a body, an actuator, a control unit configured to control the actuator, first electrical contact members that are housed in the body, wherein each of the members is configured to be connected to and to be translatable along a distinct radial direction in a connection plane, a first magnetic architecture for ensuring bonding, via a magnetic effect, of the plug, a driver for driving rotation of the first magnetic architecture on itself about a principal axis that is perpendicular to the connection plane, which are arranged to make the magnetic architecture assume a plurality of distinct angular positions about the principal axis, each distinct angular position being aligned in a distinct radial direction with each contact member of the first electrical contact members, the actuator being configured to actuate the rotator, and to move each electrical contact member of the first electrical contact members in a radial direction thereof, wherein the plug is connectable to the socket, wherein the plug comprises a second magnetic architecture that is complementary to the first magnetic architecture and a plurality of second electrical contact members arranged in a plurality of distinct radial directions about the principal axis, wherein the first magnetic architecture and the second magnetic architecture are configured to cause the plug to assume a defined orientation about the principal axis when the plug is magnetically bonded against the socket, wherein each electrical contact member of the first electrical contact members of the socket is arranged to be connected to one distinct electrical contact member of the second electrical contact members of the plug via translation in a radial direction, wherein the electrical connecting system further comprises an orientation detector for detecting orientation of the plug when the plug is magnetically bonded to the socket, wherein the electrical connecting system further comprises an angular position determiner that determines an angular position that is to be imparted to the first magnetic architecture depending on the determined orientation, the angular position being one of a plurality of distinct angular positions, wherein the controller is further configured to control the actuator to carry out steps of: positioning the first magnetic architecture in the determined angular position and moving each electrical contact member of the first electrical contact members in a radial direction thereof when the first magnetic architecture has been positioned in the determined angular position, wherein disconnecting the electrical plug from the socket comprises controlling the actuator so as to actuate rotation of the rotary ring and to make the first magnetic architecture pass from a high position thereof to a low position thereof, controlling the actuator so as to actuate the rotator so as to cause the first magnetic architecture to rotate by a defined first angle, and controlling the actuator so as to actuate each of the first electrical contact members and mechanically and electrically disconnect each of the electrical contact members from the second electrical contact members.

23. The method of claim 22, further comprising controlling the actuator so as to actuate rotation of the protecting part to occlude access to each of the first electrical contact members.

24. The method of claim 22, further comprising controlling the actuator so as to actuate rotation of the driver the first magnetic architecture by an angle opposite to the first angle.
